(19) United States
(12) Patent Application Publication
(10) Pub. No.: US 2009/0041428 A1
(43) Pub. Date: Feb. 12, 2009

(54) RECORDING AUDIO METADATA FOR CAPTURED IMAGES

(76) Inventors: Keith A. Jacoby, Rochester, NY (US); Chris W. Honsinger, Ontario, NY (US); Thomas J. Murray, Cohocton, NY (US); John V. Nelson, Rochester, NY (US)

Correspondence Address: Frank Pincelli;Patent Legal Staff, Eastman Kodak Company, 343 State Stret, Rochester, NY, 14650-2201, US

(21) Appl. No.: 11/834,745

(22) Filed: Aug. 7, 2007

(51) Int. Cl. H04N 5/91

(52) U.S. Cl. 386/104

(57) ABSTRACT

A method of recording audio metadata during image capture: includes providing an image capture device for capturing still or video digitized images of a scene and for recording audio signals; recording the audio signals continuously in a buffer while the device is in power on mode; and initiating the capture of a still image or of a video image by the image capture device, and storing as metadata, audio signals produced for a time prior to, during, and after the termination of the capture of the still or video images.

### FIELD OF THE INVENTION

The invention relates generally to the field of audio processing, and in particular to embedding audio metadata in an image file of an associated still or video digitized images.

### BACKGROUND OF THE INVENTION

Digital cameras often include video capture capability. Additionally, some digital cameras have the capability of annotating the image capture data with audio. Often, the audio waveform is stored as digitally encoded audio samples and placed within the file format's appropriate container, e.g. a metadata tag in a digital still image file or simply as an encoded audio layer(s) in a video file or stream.

There have been many innovations in the consumer electronics industry that marry image content with sound. For example, Eastman Kodak Company in U.S. Pat. No. 6,496,656 B1 teaches how to embed an audio waveform in a hardcopy print. Another Kodak patent U.S. Pat. No. 6,993,196 B2 teaches how to store audio data as non-standard meta-data at the end of an image file.

The Virage Company has one patent, U.S. Pat. No. 6,833,865, which teaches about a system for real time embedded metadata extraction that can be scene or audio related so long as the audio already exists in the audio-visual data stream. The process can be done parallel to capture or sequentially.

U.S. Pat. No. 7,113,219B2 is a Hewlett Packard patent that teaches the use of a first position on a button to capture audio and a second position to capture an image.

Although such audio information resides in the image or video file for playback purposes, the audio serves no further purpose other than allowing for the sound to be played back at a later time when viewing the file. Currently there is no mechanism for automatically capturing the audio event concurrent with a digital image or video capture, either at the time of capture or at a later time, for the purposes of subsequent analysis for understanding, organization, categorization, or search/retrieval.

### SUMMARY OF THE INVENTION

Briefly summarized, in accordance with the present invention, there is provided a method of recording audio metadata during image capture, comprising:

a) providing an image capture device for capturing still or video digitized images of a scene and for recording audio signals;

b) recording the audio signal continuously while the device is in power on mode; and

c) initiating the capture of a still image or of a video image by the image capture device, and storing as metadata audio signals produced for a time prior to, during, and after the termination of the capture of the still or video images.

The present invention automatically associates audio metadata with image capture. Further, the present invention automatically associates a pre-determined segment of concurrent audio information with an image or video sequence of images.

It is understood that the phrases “image capture”, “captured image”, “image data” as used in this description of the present invention relate to still image capture as well as moving image capture, as in a video. When called for, the terms “still image capture” and “video capture”, or variations thereof, will be used to describe still or motion capture scenarios that are distinct.

An advantage of the present invention stems from the fact that recorded audio information that is captured prior to, during, and after image capture provides context of the scene, and useful metadata that can be analyzed for a semantic understanding of the captured image. A process, in accordance with the present invention, associates a constantly updated, moving window of audio information with the captured image, allowing the user the freedom of not having to actively initiate the audio capture through actuation of a button or switch. The physical action required by the user is to initiate the image or video capture event. The management of the moving window of audio information and association of the audio signal with the image(s) is automatically handled by the device's electronics and is completely transparent to the user.

These and other aspects, objects, features and advantages of the present invention will be more clearly understood and appreciated from a review of the following detailed description of the preferred embodiments and appended claims, and by reference to the accompanying drawings.

The present invention includes these advantages: Continuous capture of audio in power on mode stored in memory allows for capture of more information that can be used for semantic understanding of image data, as well as an augmented user experience through playback of audio while viewing the image data. At the time of image capture, the audio samples from a period of time before, during and for a period of time after still and video captures are automatically stored as metadata in the image file for semantic analysis at a later time.

### BRIEF DESCRIPTION OF THE DRAWINGS

FIG. 1a is block diagram that depicts an embodiment of the invention;

FIG. 1b shows a multimedia file containing image and audio data;

FIG. 2a is a cartoon depicting a representative photographic environment, containing a camera user, a subject, scene, and other objects that produce sounds in the environment;

FIG. 2b is a flow diagram illustrating the high-level events that take place in a typical use case, using the preferred embodiment of the invention;

FIG. 3a is a detailed diagram showing the digitized audio signal waveforms as a time-variant signal that overlaps a still image capture scenario;

FIG. 3b is a detailed diagram of the digitized audio signal waveforms specific to a video capture scenario; and

FIG. 4 is a block diagram of the analysis process shown in FIG. 1a for analyzing the recorded audio signals.

### DETAILED DESCRIPTION OF THE INVENTION

In the following description, the present invention will be described in its preferred embodiment as a digital camera device. Those skilled in the art will readily recognize that the equivalent invention can also exist in other embodiments.

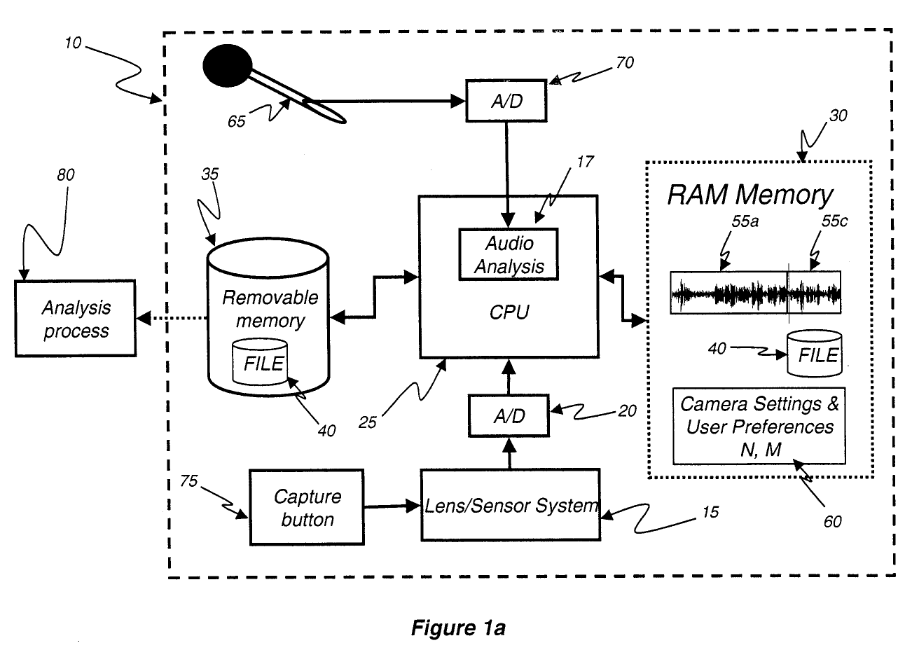

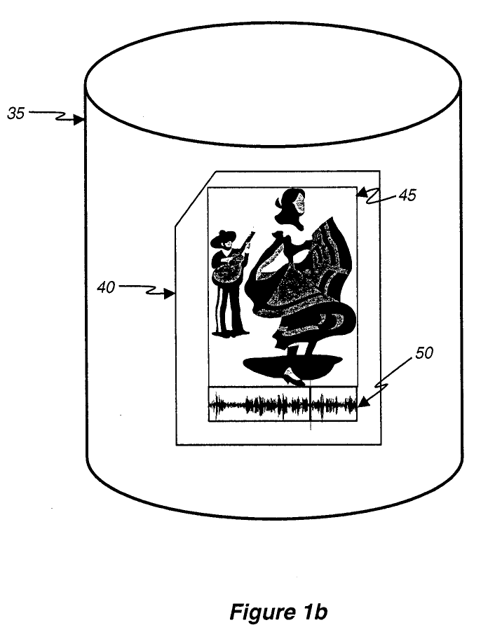

FIG. 1a shows a schematic diagram of a digital camera device 10. The digital camera device 10 contains a camera lens and sensor system 15 for image capture. The image data 45 (see FIG. 1b) can be an individual still image or a series of images as in a video. These image data are quantized by a dedicated image analog to digital converter 20 and a computer CPU 25 processes the image data 45 and encodes it as a digital multimedia file 40 to be stored in internal memory 30 or removable memory module 35. The internal memory 30 also provides sufficient storage space for a pre-capture buffered audio signal 55a and a post-capture buffered audio signal 55c, and for camera settings and user preferences 60. In addition the digital camera device 10 contains a microphone 65, which records the sound of a scene, or records speech for other purposes. The electrical signal generated by the microphone 65 is digitized by a dedicated audio analog to digital converter 70. The digital audio signal 175 is stored in internal memory 30 as a pre-capture buffered audio signal 55a and a post-capture buffered audio signal 55c.

FIG. 1b shows a diagram of a removable memory module 35 (e.g. an SD memory card or memory stick) containing a digital multimedia file 40. The file contains the afore-mentioned image data 45, and an accompanying audio clip 50.

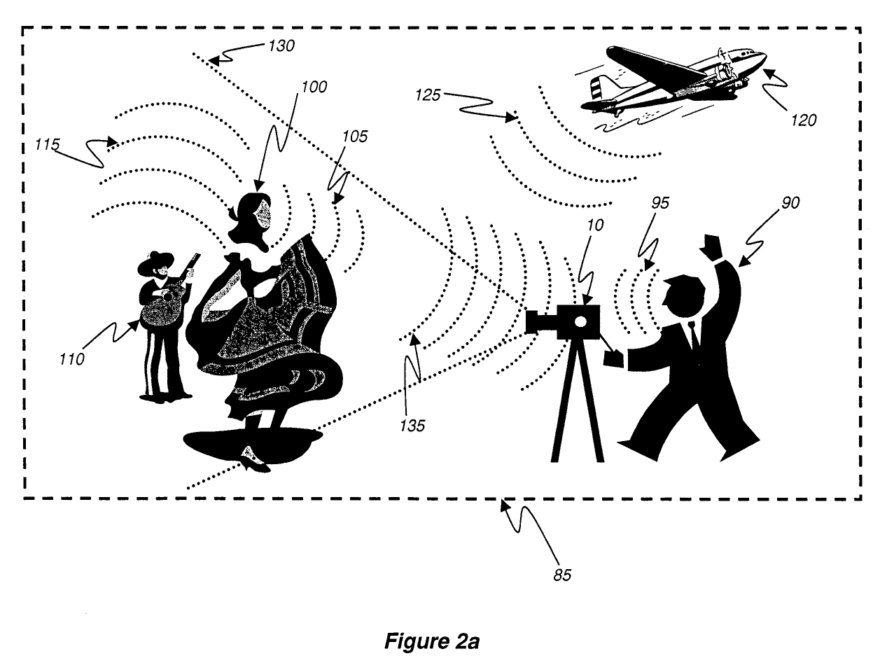

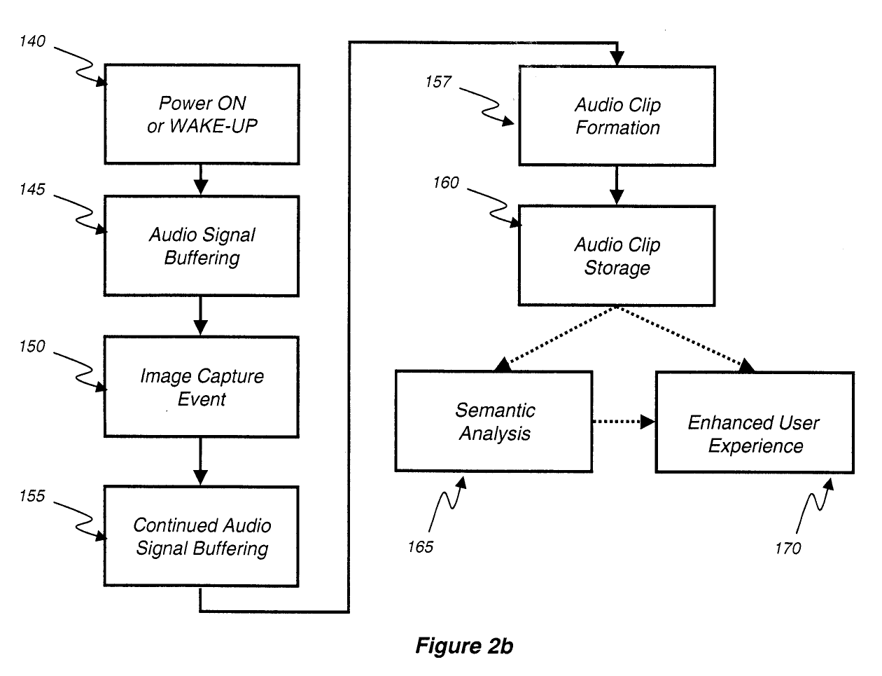

The operation of the various components described in FIG. 1a can be better understood within a common use scenario of the preferred embodiment, depicted in FIG. 2a, which depicts a representative photographic environment. Referring to FIG. 2a, a photographer 90 with a digital camera device 10 interacts verbally with a subject 100 in an environment 85. The environment 85 is defined as the space in which objects are either visible or audible to the digital camera device 10. The utterances 95 and 105 of the photographer 90 and the subject 100 respectively, can be part of a dialog, or can be one-way, produced by either the subject 100 or the photographer 90 as in a narrative or annotation. A photographic scene 130 is defined as the optical field of view of the digital camera device 10. There can be other scene-related ambient sound 115 produced by other scene-related objects 110 in the environment 85. In the case of FIG. 2a, the scene-related object 110 is a musician who is within the photographic scene 130. The non-scene-related ambient sound 125 from the non-scene-related object 120, shown as an airplane, is audible to the microphone 65 and are therefore part of the environment 85 the digital camera device 10 senses, however they are not part of the photographic scene 130. Further illustrated in FIG. 2a is the aggregate sound 135, defined to be the sum total of all the sound sources within the environment 85 incident upon the microphone 65.

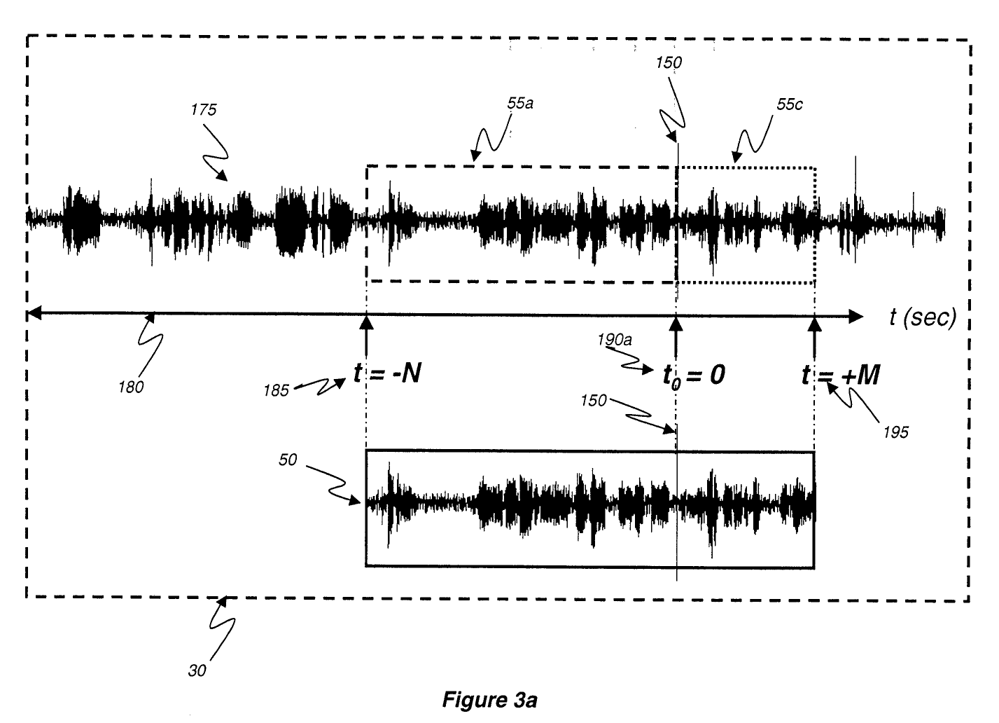

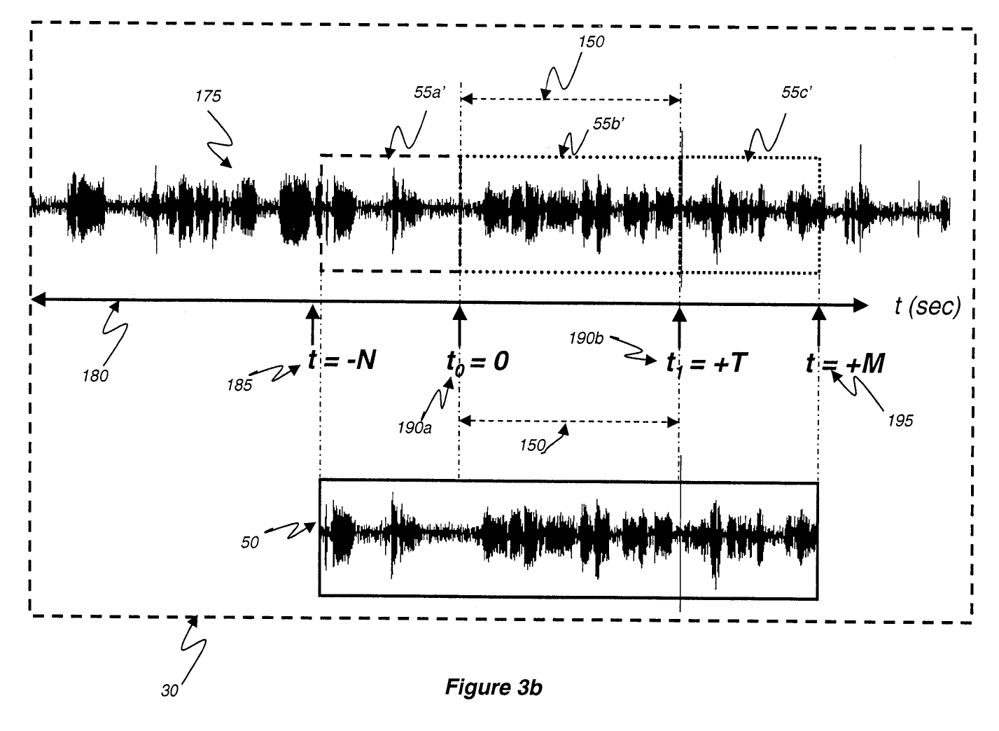

FIG. 2b is a flow diagram of the sequence of events involving the capture of a still image of the photographic scene 130, shown in FIG. 2a. Referring to FIG. 2b, the digital camera device 10 power on or wake-up step 140 shows the activation of the digital camera device 10 by turning the power on, or otherwise waking up from a sleep or standby mode. This step is important, because in the audio signal buffering step 145 the digital camera device 10 immediately begins storing the digital audio signal 175 (see FIG. 3a) produced by the microphone 65 as the pre-capture buffered audio signal 55a. The audio signal buffering step 145 permits the photographer 90 to engage in conversation with, or describe, the subject 100 or other attributes of the photographic scene 130 or environment 85 prior to the image capture event 150. Concurrently, there may also be other non-verbal sounds occurring that are sensed by the microphone 65, such as scene-related ambient sound 115 or other non-scene-related ambient sound 125 discussed earlier, which can add additional context to the ensuing image capture event 150. It is important to note that in the audio signal buffering step 145 the microphone 65 and audio analog to digital converter 70 records the aggregate sound 135 occurring in the environment 85. In the image capture event 150, the photographer 90 presses the capture button 75 (see FIG. 1a), which initiates capture of image data 45 of the photographic scene 130. In the continued audio signal buffering step 155 the digital camera device 10 continues to record the aggregate sound 135 from the environment 85 for an additional period of time specified in the camera settings and user preferences 60.

At this point the flow diagram of FIG. 2b shows in greater detail what happens during the audio signal buffering step 145 thru the continued audio signal buffering step 155. Referring to FIG. 3a, there is shown the aggregate sound 135 picked up by the microphone 65 as a representation of a digital audio signal 175, and an associated timeline 180. As was previously stated, in the audio signal buffering step 145, the aggregate sound 135 is continuously stored as a pre-capture buffered audio signal 55a. The pre-capture buffered audio signal 55a stores N seconds of audio information, as shown on the timeline 180 by the “t=−N” time marker 185 on the timeline 180. The “t=−N” time marker 185 designates the starting point in time of the pre-capture buffered audio signal 55a. This pre-capture buffered audio signal 55a is continuously updated in a “moving window” fashion, with the oldest samples spilling off the end of the buffer at the “t=−N” time marker 185 and the current audio sample filling the front end of the buffer at the “t₀=0” time marker 190a on the timeline 180. The “t₀=0” time marker 190a represents the present moment in real time while the digital camera device 10 is on and listening to the aggregate sound 135 occurring in the environment 85. The pre-capture buffered audio signal 55a can be thought of as a moving window of sound that is constantly updated in a FIFO (First In, First Out) vector of samples spanning from the “t=−N” time marker 185 to the “t₀=0” time marker 190a.

Referring back to FIG. 2b, the image capture event 150 (i.e. the photographer 90 pressing the capture button 75) coincides with the completion of population of the pre-capture buffered audio signal 55a. At the time of the image capture event 150 which occurs at the “t₀=0” time marker 190a, the continued audio signal buffering step 155 shows the digital audio signal 175 continuing to fill a post-capture audio data buffer 55c for an additional M seconds, as shown by the “t=+M” time marker 195 on the timeline 180. In the case of a still image capture, it is an idealization that the image capture event 150 (see FIG. 3a) captures an infinitesimal instant in time, however the image capture event actually spans the duration of the shutter or integration time of the sensor. For example, the exposure time of the digital camera device 10 may be set at 1/20 second in the camera settings and user preferences 60. The audio during this fraction of a second is preserved in a seamless way to span the digital audio signal 175 from the “t=−N” time marker 185 to the “t=+M” time marker 195. In the audio clip formation step 157 the pre-capture buffered audio signal 55a and post-capture buffered audio signal 55c are combined to form the audio clip 50 (see FIG. 3a).

FIG. 3b shows a diagram of the audio waveforms specific to a video capture scenario, where the aggregate sound 135 (see FIG. 2a) is recorded while the digital camera device's 10 camera lens and sensor system 15 (see FIG. 1a) records the image data 45 (see FIG. 1b) as video frames. The image data 45 is captured while the digital audio signal 175 continues to be recorded and stored as an audio portion of the video stream 55b′ for the duration of the image capture event 150; e.g. for an additional T seconds, as shown by the span of time from the “t₀=0” time marker 190a to the “t₁=+T” time marker 190b after the image capture event 150 is completed. The pre-video-capture buffered audio signal 55a′, audio portion of the video stream 55b′, and post-video-capture buffered audio signal 55c′ are merged to form an audio clip 50, which is associated with the image capture event 150.

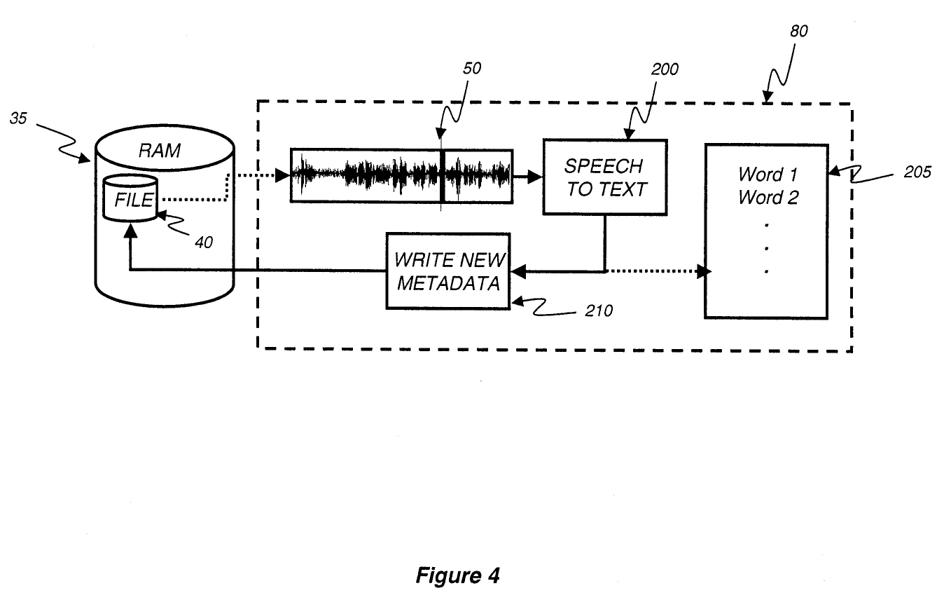

Referring back to FIG. 2b, in the case of video capture, the audio clip formation step 157 combines the pre-video-capture buffered audio signal 55a′, audio portion of the video stream 55b′, and the post-capture buffered audio signal 55c′ (see FIG. 3b). The audio clip storage step 160 stores the audio clip 50 as part of the digital multimedia file 40. In the semantic analysis step 165, the audio clip 50 undergoes further analysis by a semantic analysis process 80 (see FIG. 1a). Finally, the enhanced user experience step 170 shows that the audio clip 50 can be used for an enhanced user experience. For example, the audio clip 50 can simply be played back while viewing the image data. Additionally, information gleaned from the audio clip 50 as a result of the semantic analysis step 165 constitutes new metadata 205 (see FIG. 4) and can be used, for example, to enhance semantic-based media search and retrieval.

FIG. 4 is a more detailed block diagram of the audio data analysis for semantic analysis step 165 (see FIG. 2b). A semantic analysis process 80, which in the preferred embodiment of the invention is a speech to text operation 200, converts speech utterances present in the audio clip 50 into new metadata 205. Other analyses can be done, for example examining the audio clip 50 to aid in semantic understanding of the capture location and conditions, detecting presence or identities of objects or people. In the preferred embodiment, the new metadata 205 takes the form of a list of recognized key words, or it can be a list of phrases or phonetic strings. New metadata 205 is associated with the digital multimedia file 40 by a write metadata to file operation 210.

Referring back to FIG. 3a and 3b, the time durations of the pre-capture buffered audio signal 55a (pre-video-capture buffered audio signal 55a′) and post-capture buffered audio signal 55c (post-video-capture buffered audio signal 55c′) have default values and are user-adjustable in the camera settings and user preferences 60 (see FIG. 1a), which are stored in the internal memory 30. For example, a pre-capture buffered audio signal 55a default duration can be preset in the camera settings and user preferences 60 for N=10 seconds, and the post-capture buffered audio signal 55c default duration can be preset in the camera settings and user preferences 60 for M=5 seconds. The durations of the buffers are arbitrary and are user-adjustable in the event that more or less time is required.

Multiple buffers in the internal memory 30 (see FIG. 1a) can be supported if another capture event 150 is initiated while the post-capture buffered audio signal 55c is still in the process of populating itself with audio samples, as would be the case in a burst-mode capture.

Another method of achieving an equivalent audio clip 50 would be to store the entirety of the digital audio signal 175 (see FIGS. 3a, 3b) in the digital camera device's 10 internal memory 30, provided the storage capacity of the internal memory 30 is adequate. At such time that the user wishes to capture image data 45 (see FIG. 1b), the user presses the capture button 75 (see FIG. 1a) to initiate a capture event 150 (see FIGS. 3a, 3b) which occurs at “t₀=0” time marker 190a. At the initial “t₀=0” time marker 190a of the capture event 150, a shifting time pointer located at the “t=−N” time marker 185 N seconds prior to the “t₀=0” time marker defines the beginning of the audio clip 50, which will include the audio samples from the “t=−N” time marker 185 to “t=+M” time marker 195 once the post-capture buffered audio signal 55c has completed.

In addition to having preset lengths of time to capture the audio for both before and after the image capture event, it may also be prudent to analyze the digital audio signal 175 in real time to determine the continuity of the audio, before ‘cutting it off’. For example, a continuous audio analysis process 17 (see FIG. 1a) that occurs within the digital camera device's 10 computer CPU 25 can analyze the digital audio signal 175 (see FIGS. 3a, 3b) in real time and determine appropriate locations to begin and end the audio clip. For example, if the digital audio signal 175 includes a spoken monologue, a longer or shorter pre-capture buffered audio signal 55a would be saved by automatic adjustment of the “t=−N” time marker 185, or a longer or shorter post-capture buffered audio signal 55c would be saved by automatic adjustment of the “t=+M” time marker 195, in order to maintain the continuity of the digital audio signal 175. Finding a convenient break in the digital audio signal 175, based on audio continuity or loudness thresholds, allows the system to clip the digital audio signal 175 appropriately, whereas a ‘fixed’ time may cut the digital audio signal 175 off in mid-word. Put another way, one may desire to have the digital audio signal 175 capture terminated if the digital audio signal 175 drops below a threshold for a pre-determined amount of time, thus saving file space for those instances when sound is not important. Conversely, there may be so much noise that the sound is ‘useless’ for semantics or reuse . . . . The audio analysis process 17 would employ a threshold for audio usability and throw out any loud, non-discernable or continuous noise.

### PARTS LIST

10 Digital Camera Device
15 Camera Lens and Sensor System
17 Audio Analysis Process
20 Image Analog to Digital Converter
25 Computer CPU
30 Internal Memory
35 Removable Memory Module
40 Digital Multimedia File
45 Image Data
50 Audio Clip
55a Pre-Capture Buffered Audio Signal
55a′ Pre-Video-Capture Buffered Audio Signal
55b′ Audio Portion of the Video Stream
55c Post-Capture Buffered Audio Signal
55c′ Post-Video-Capture Buffered Audio Signal
60 Camera Settings and User Preferences
65 Microphone
70 Audio Analog to Digital Converter
75 Capture Button
80 Semantic Analysis Process
85 Environment
90 Photographer
95 Utterances/Sounds of the Photographer
100 Subject
105 Utterances/Sounds of the Subject
110 Scene-Related Object
115 Scene-Related Ambient Sound
120 Non-Scene-Related Object
125 Non-Scene-Related Ambient Sound
130 Photographic Scene
135 Aggregate Sound
140 Device Power On or Wake-Up Step
145 Audio Signal Buffering Step
150 Image Capture Event (Still or Video)
155 Continued Audio Signal Buffering Step
157 Audio Clip Formation Step
160 Audio Clip Storage Step
165 Semantic Analysis Step
170 Enhanced User Experience Step
175 Digital Audio Signal
180 Timeline
185 t=−N Time Marker
190a t₀=0 Time Marker
190b t1=T Time Marker
195 t=+M Time Marker
200 Speech to Text Operation
205 New Metadata
210 Write Metadata to File Operation

1. A method of recording audio metadata during image capture, comprising:
a) providing an image capture device for capturing still or video digitized images of a scene and for recording audio signals;
b) recording the audio signals continuously in a buffer while the device is in power on mode; and
c) initiating the capture of a still image or of a video image by the image capture device, and storing as metadata, audio signals produced for a time prior to, or during, and after the termination of the capture of the still or video images.

2. The method of claim 1, further including providing at least one microphone in the image capture device and digitizing audio signals captured by the microphone so that the recorded metadata audio signals are digitized.

3. The method of claim 1, wherein the audio information is temporarily stored in a moving window memory buffer.

4. The method of claim 1, further including inclusion of the audio signal captured during video image capture with the audio signals stored in the memory and audio signals produced during a predetermined time after the termination of the capture of the video images.

5. The method of claim 1, further including providing a default duration for the audio buffers.

6. The method of claim 1, further including adjusting the time durations of the audio buffers to be set according to a user preference.

7. The method of claim 6, further providing an automatic mode for determining the duration of the pre-capture audio buffer and the duration of the post-capture audio buffer based on an analysis of the audio signal.

8. The method of claim 1, wherein the audio signals are stored in memory in its entirety, and memory addresses mark the beginning and end of the audio metadata to be associated with the image data.

9. The method of claim 7, further including encompassing the adjustment of the memory addresses for the beginning and end of the audio metadata to be associated with the image data.

10. The method of claim 2, further including providing an image file associated with captured images having a digitized image and digitized audio metadata.

11. The method of claim 4, further including providing a removable memory card for storing image files.

12. The method of claim 4, further including analyzing the audio metadata to provide a semantic understanding of the captured still or video images.

13. The method of claim 6, further including providing a written text of the audio metadata.

14. The method of claim 6, further including providing a description of ambient sounds that occur in the audio metadata.

15. The method of claim 6, further including providing the identity of a speaker in the audio metadata.

16. The method of claim 6, wherein the analysis of the audio metadata occurs within the capture device.

17. The method of claim 6, wherein the analysis of the audio metadata occurs on a computing device other than the capture device;

18. The method of claim 6, further including the updating of the metadata of the existing image file with the additional metadata obtained from the analysis.

19. The method of claim 1, further including storing audio information prior to an image capture.

20. The method of claim 1, further including combining stored audio to form an audio clip.

21. The method of claim 1, wherein the time prior to, during, and after the termination of the capture of the still or video images is adjustable.

22. The method of claim 20, further including using the audio clip to provide semantic understanding of the audio information, to be used for media search/retrieval.

23. The method of claim 1, further including providing burst capture mode with multiple audio buffers for each still image in the burst capture sequence.
